(19) United States
(12) Patent Application Publication
(10) Pub. No.: US 2011/0267448 A1
(43) Pub. Date: Nov. 3, 2011

(54) MICROSCOPY

(75) Inventor: Nicholas Thomas, Cardiff (GB)

(73) Assignee: GE HEALTHCARE UK LIMITED, LITTLE CHALFONT (GB)

(21) Appl. No.: 13/143,369

(22) PCT Filed: Jan. 6, 2010
(86) PCT No.: PCT/EP10/50073

§ 371 Date: Jul. 6, 2011

(30) Foreign Application Priority Data
Jan. 7, 2009 (GB) 0900191.8

(51) Int. Cl. H04N 7/18; C40B 40/06; C40B 40/00; G06K 9/00

(52) U.S. Cl. 348/79; 382/181; 506/16; 506/13

(57) ABSTRACT

According to one aspect, the present invention relates to an imaging system (100) for providing improved spatial position identification of a plurality of microscopy images. The imaging system (100) comprises a light source (102) for producing light (120a), a test plate (108) containing an array of spots (109) to be imaged, a condenser (104) for focussing the light (120) on the test plate (108), a translation mechanism for moving the focal plane of the light (120b) relative to the test plate (108), a detector system (112) configured to acquire a plurality of original images from respective spots (109), and an image processing device (114) operable to process the plurality of images to generate data indicating accurately the relative position of the test plate (108) within the imaging system (100).

### FIELD

The present invention relates generally to microscopy. More particularly, the present invention relates to methods and apparatus for image processing of microscopy images in order to provide improved spatial position identification.

### BACKGROUND

In microscopy, it is known to form high resolution images of arrays of spots used in, for example, a large scale reverse transfection small interfering ribonucleic acid (siRNA) array.

However, a key requirement in imaging such an array is the accurate and precise alignment and registration of many imaging locations with array features (e.g. many thousands of siRNA spots).

Various approaches have been taken to address this requirement [1-13]. One approach is to accurately and precisely position the spotted array relative to the boundaries of an array plate and acquire images at a series of defined coordinates in order to match imaging locations with array spots.

However, experience to date has shown that variations in plate dimensions and geometry, variations in geometry of the array and variations in stage positioning can introduce cumulative errors in image to spot registration across the array.

Hence, to allow correction for feature-image registration errors, fiducial marker spots may be used to allow location of array features by imaging with subsequent alignment of feature-image registration following corrective stage movement during imaging of each feature.

Although such an approach can provide the requisite accuracy needed to image the array, such an approach is slow. For example, each corrective stage movement may add approximately 0.2 seconds to an image acquisition time and, where many thousands of such images are required, the total time to image the whole area of such an array can become prohibitively long.

### PRIOR ART

U.S. Pat. No. 6,990,221, BioDiscovery, Inc. (“Automated DNA array image segmentation and analysis”), describes a method of segmentation of a single frame image of DNA spots using a user defined grid corresponding to a known number and arrangement of spot features wherein the grid overlaid on the single image is subsequently shifted and/or warped to bring the grid points over regions of highest intensity values corresponding to the array spots.

U.S. Pat. No. 6,980,677, Niles Scientific, Inc. (“Method, system, and computer code for finding spots defined in biological microarrays”), discloses methods for locating microarray spots in a single image wherein the array features are disposed in regular rectangular groups of spots separated by isolation regions which are free of spots. Image processing and segmentation is applied using a frequency filter wherein the frequency corresponds to the spacing of the isolation regions, this process allowing the identification of the isolation regions and hence locates the positions of the groups of spots.

U.S. Pat. No. 6,789,040, Affymetrix, Inc. (“System, method, and computer software product for specifying a scanning area of a substrate”), describes an arrayer manager and scanner control application. The arrayer manager controls the printing of array spots at user defined locations and stores the spot locations as x,y coordinates. The scanner control application receives the stored location data and scans the array to image the defined locations.

WO2008065634, Koninklijke Philips Electronics N.V. (“Method to automatically decode microarray images”), discloses methods of removing optical scanning distortions from a single microarray image by iterative adjustment using corner and spot line detection to rotate and/or warp the captured image to correspond to a predetermined grid location of spots to allow intensity measurement of spot features.

U.S. Pat. No. 7,359,537, Hitachi Software Engineering Co. (“DNA microarray image analysis system”), describes a microarray image analysis program which automatically identifies and flags faulty array spots in single microarray images according to learned features.

U.S. Pat. No. 7,130,458, Affymetrix, Inc. (“Computer software system, method, and product for scanned image alignment”), discloses methods for applying analysis grids to a single microarray image wherein a first grid is applied to the array and each grid position checked for the presence of a spot. In the event of grid locations not containing spots additional grids may be applied to account for deviation of the array spots in the image from predicted positions.

US20040208350, Rea at al. (“Detection, resolution, and identification of arrayed elements”), describes an image analysis workstation for analyzing optical thin film arrays which supports software methods for rotating images, finding image edges and applying a predetermined grid for the purpose of measuring arrayed elements.

U.S. Pat. No. 6,673,315, BioMachines, Inc. (“Method and apparatus for accessing a site on a biological substrate”), discloses the use of global and local fiducial markers for the purpose of locating regions of interest on a substrate supporting a biological assay. The apparatus may comprise macro and micro images used to identify global and local markers, respectively.

U.S. Pat. No. 6,826,313, University of British Columbia (“Method and automated system for creating volumetric data sets”), describes means for producing quantitative volumetric data by combination of planar data sets derived from multiple analogue images aligned through use of fiducial marking. Data derived from the analogue images is aligned in two dimensional space using the fiducial markers and used to populate a three dimensional volumetric data matrix.

U.S. Pat. No. 6,798,925, Cognex Corporation (“Method and apparatus for calibrating an image acquisition system”) discloses the use of fiducial marks for alignment and calibration in a machine vision system. Fiducial marks may be used to correct for rotational or translational variations introduced by the imaging process.

U.S. Pat. No. 6,362,004, Packard BioChip Technologies LLC (“Apparatus and method for using fiducial marks on a microarray substrate”), describes the use of fiducial marks on microarray substrates wherein the stored locations of the marks are used to apply image translation and rotation, to minimize the distance between all fiducial marks in images acquired of the same region at different imaging wavelengths so as to register microarray spots across images of different fluorescent markers.

U.S. Pat. No. 5,940,537, Tamarack Storage Devices (“Method and system for compensating for geometric distortion of images”), discloses means using fiducial marks for correcting a variety of image distortions in two dimensional images. Location of fiducial points corresponding to a known layout within an image allows rotation, warping or other manipulations of the image to bring the fiducial marks within the image into the known layout, so correcting image distortion.

US20020150909, Stuelpnagel et al. (“Automated information processing in randomly ordered arrays”), describes imaging and analysis of random orientated arrays. Arrays comprised beads randomly distributed on a surface which has at least one known fiducial marker position. The array is imaged and the locations of the randomly distributed beads are recorded and an analysis grid generated recording bead position relative to the fiducial. The array is then exposed to an analyte and the array imaged to detect the analyte. The analysis grid is applied to the analyte image to determine the amout of analyte signal present in the analyte image at the positions described in the grid.

### SUMMARY OF INVENTION

The present invention has thus been devised whilst bearing the above-mentioned drawbacks associated with conventional microscopy imaging techniques in mind.

According to a first aspect of the present invention, there is provided an imaging system for providing improved spatial position identification of a plurality of microscopy images. The imaging system comprises a light source for producing light, a test plate containing an array of spots to be imaged, a condenser for focussing the light on the test plate, a translation mechanism for moving the focal plane of the light relative to the test plate, a detector system configured to acquire a plurality of original images from respective spots, and an image processing device operable to process the plurality of images to generate data indicating the relative positions of the test plate and the individual elements comprising the array within the imaging system.

According to a second aspect of the present invention, there is provided a test plate for use in an imaging system in accordance with the first aspect of the present invention.

According to a third aspect of the present invention, there is provided a method of spatially registering a plurality of microscopy images. The method comprises processing a plurality of original images of spots to generate data indicating the relative position of a test plate within an imaging system.

In various embodiments of the present invention, each of the plurality of original images may be processed to reduce the information content therein, a composite image may be formed from the plurality of processed reduced information content images, the spatial location of at least one fiducial marker in the composite image may be identified, and data indicating the relative position of a test plate within an imaging system generated from the spatial location of the at least one fiducial marker.

By generating data indicating the relative position of a test plate within an imaging system, various aspects of the present invention are able to compensate for cumulative tracking errors, for example, of stepping stages and to more rapidly identify the spatial position of microscopy images.

Additionally, various embodiments of the present invention are able automatically to provide improved spatial position identification without the need to add complex and expensive hardware modifications to conventional imaging systems, and without adding significant extra processing requirements.

### BRIEF DESCRIPTION OF THE DRAWINGS

Various aspects and embodiments of the present invention will now be described in connection with the accompanying drawings, in which:

FIG. 1 shows an imaging system for producing and analysing microscopy images in accordance with an embodiment of the present invention;

FIG. 2 shows a method for acquiring and processing a plurality of microscopy images in accordance with various aspects and embodiments of the present invention;

FIG. 3 shows a process workflow diagram in accordance with various embodiments of the present invention;

FIG. 4 shows a high resolution image of a single spot obtained using a GE IN Cell Analyzer 1000™ apparatus with various reduced information content images obtained therefrom in accordance with an aspect of the present invention;

FIG. 5 illustrates a composite image formed from a plurality of reduced information content images in accordance with an embodiment of the present invention; and

FIG. 6 shows a feature coordinates map produced in accordance with an embodiment of the present invention.

### DETAILED DESCRIPTION

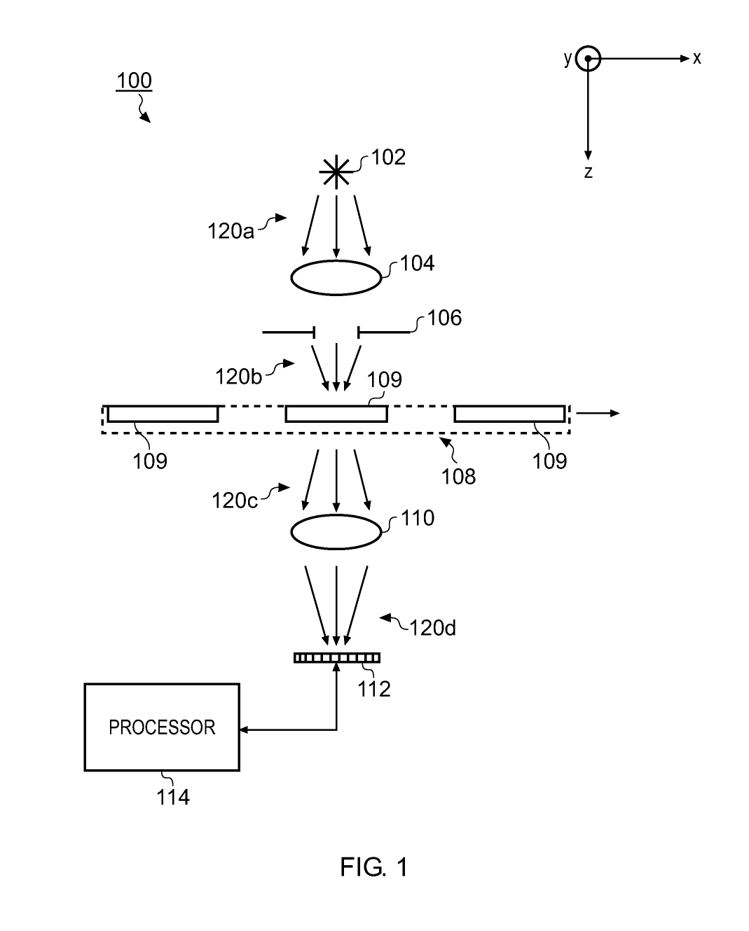

FIG. 1 shows an imaging system 100 for producing and analysing microscopy images in accordance with an embodiment of the present invention. The imaging system 100, which is illustrated schematically for clarity, comprises a light source 102 for producing light 120a.

The light 120a is focussed by a condenser 104 onto a test plate 108. The test plate 108 may contain an array of spots 109 to be imaged. The condenser 104 can focus the light 120b in a focal plane at the test plate 108. The test plate 108 may be provided as a consumable product, and the spots 109 might contain various materials that are able to interact with certain types of cells (e.g. mammalian cells).

In one embodiment, the test plate is a new type having dimensions of about 80 mm×120 mm. It differs from conventional smaller scale plates in that it is larger in size and has smaller spots.

In such conventional smaller scale plates, where the number of spots is small and compatible with printing in a single block, the errors arising in the spotting process are small, and this coupled with the use of larger spots (e.g. where spot diameter d is >> image width W) allows imaging at pre-defined positions while still filling the image with cells overlaying spots.

In contrast, one problem addressed by aspects of the present invention occurs when the array is large requiring multiple block printing by a spotting robot (which leads to deviations from a perfect grid) and when the dimensional tolerances of the device are large enough when coupled with the small spot size required to fit the desired number of spots into the available area to make the task of aligning imaging and spot position difficult.

For example, in various preferred embodiments, the spots 109 contain strands of small interfering ribonucleic acid (siRNA) that can inactivate certain genes within cells that are provided in a solution that is flooded over the spots 109. In various embodiments, many thousands of such spots 109 can be provided in a single array. For example, the array of spots 109 may be a large array having, for example, >1000, >5000, >10,000, >20,000 (e.g. 22,528), etc. of such spots 109.

In various embodiments, the test plate 108 may comprise at least one fiducial marker (not shown) provided to aid in aligning the test plate 108 within the imaging system 100. For example, one or more coloured dyes may be provided within the spots 109. Such coloured dyes can be identified by various imaging systems in order to derive data relating to the relative positioning of the test plate 108 within the imaging system 100. For example, the imaging system 100 may be a GE IN Cell Analyzer 1000™ that is commercially available from GE Healthcare Life Sciences, Little Chalfont, Buckinghamshire, U. K., and which can use four colour channels to image the test plate 108. One colour channel may thus be dedicated to imaging coloured fiducial markers provided in various of the spots 109 in order to obtain data relating to the positioning of the test plate 108 within the imaging system 100.

The imaging system 100 also contains a detector system 112 and a translation mechanism (not shown). The translation mechanism is configured to move the focus of the light 120b relative to the test plate 108 (e.g. by moving the test plate 108 in the x-y plane). This enables a plurality of images to be acquired from respective of the individual spots 109. Additionally, the translation mechanism may also be operable to move the test plate 108 in the z-direction shown in FIG. 1, for example, in order to bring the spots 109 into focus.

For certain embodiments, only one spot is imaged at a time. The images acquired are of sufficient magnification to resolve cells and sub-cellular morphology. With the current GE IN Cell Analyzer 1000™, this means using a 20× objective, the field of view of which is slightly smaller than a single spot. However, various methods of the invention would also work for lower power magnification imaging, e.g. on GE IN Cell Analyzer 1000™ using a 4× objective to image 4-6 spots/image. For such embodiments, the process for downsizing the images, montaging and analysing to find the spots would be the same as for imaging of a single spots, but could use fewer images to cover the whole array.

An aperture stop 106 is optionally provided between the light source 102 and the detector system 112, the size of which may be variable. For example, various differently sized movable apertures may be rotated into position or a continuously variable iris-type diaphragm may be provided. Image contrast can be controlled by changing the aperture setting of the aperture stop 106.

Focussed light 120b passing through the aperture stop 106 passes through the sample test plate 108 in a transmission imaging mode. Emergent light 120c modulated with image information relating to material adjacent to an individual spot 109 is collected by an objective lens 110 and focussed 120d onto the detector system 112, and is used to form an original image for that spot 109.

Various embodiments of methods of the present invention are independent of the imaging modality used, e.g. they can operate with transmission or reflection geometry. For GE IN Cell Analyzer 1000™ imaging an epi-fluorescence mode may be used, with both the fiducial marker spots and the assay signals from the cells being imaged at different excitation and emission wavelengths. However there is nothing in principle to prevent a mix of imaging modes being deployed, provided that they do not interfere. For example, it would be possible to use a non-fluorescent dye for fiducial marking and to detect the fiducial marks by absorbance in reflectance or transmission geometry, while detecting assay signals by epi-fluorescence.

The detector system 112 is operable to acquire a plurality of the unprocessed, or original, images from the test plate 108. The detector system 112 is also operably coupled to an image processing device 114 that in turn is operable to process the plurality of images and to generate data indicating the relative position of the test plate 108 within the imaging system 100. For example, the data may provide one or more spatial position identifiers encoding two- or three-dimensional position coordinates for various of the spots 109. Alternatively, or in addition, the data might define a spatial transform that could be applied to all spot coordinates to identify their position. For example, such a spatial transform might define lateral displacement (in two or three dimensions) and/or rotational misalignment parameters that can be applied to the spot plate 108 to transform the measured coordinates of the spots 109 into perfect alignment with the imaging system 100.

The position of each spot determined from analysis of the downsized montaged image is related to the individual full resolution image(s) in order to achieve analysis of the cells overlying the array spots. Hence, for spot N at position x,y it is preferred to determine in which full size image(s) spot N centred at x,y occurs (the spot may be entirely on one image or span greater than one image, depending on the degree of error in the array). Once the image(s) are determined they can be retrieved into memory and an area of interest for analysis defined based on a circle of equivalent diameter to the spot, centred at x,y. If the spot spans more than one image, the images are retrieved and may be tiled into a single image before analysis.

The number of full resolution images retrieved for analysis following the determination of each spot position will depend on the nature of the assay and analysis. For example, in the simplest case where (a) a given spot falls entirely within one image and (b) only one fluorescent channel is used for analysis (e.g. in a nuclear morphology or DNA content assay), only one high resolution image corresponding to the determined spot position is retrieved. In more complex cases, e.g. where a given spot traverses two or more images, where more than one fluorescence channel is used for analysis, or a combination of these scenarios occurs, then the number of images retrieved may range from two (spot on two images, single channel analysis or spot on one image, dual channel analysis) to sixteen images (spot on four images, four channel analysis).

Additionally, the processor 114 can be configured to control the translation mechanism (not shown) to move the focal position of the light source 102 relative to the spot plate 108. The processor 114 may, for example, be provided as part of a computer system appropriately programmed to perform such tasks.

The imaging system 100 of various embodiment of the present invention may thus comprise a microscope with one or more cameras and an image processor. The original images that are generated can thus be processed to provide at least one spatial position identifier for the spots 109 provided on a test plate 108. Various ways of implementing such image processing functionality are described in greater detail below by way of non-limiting example.

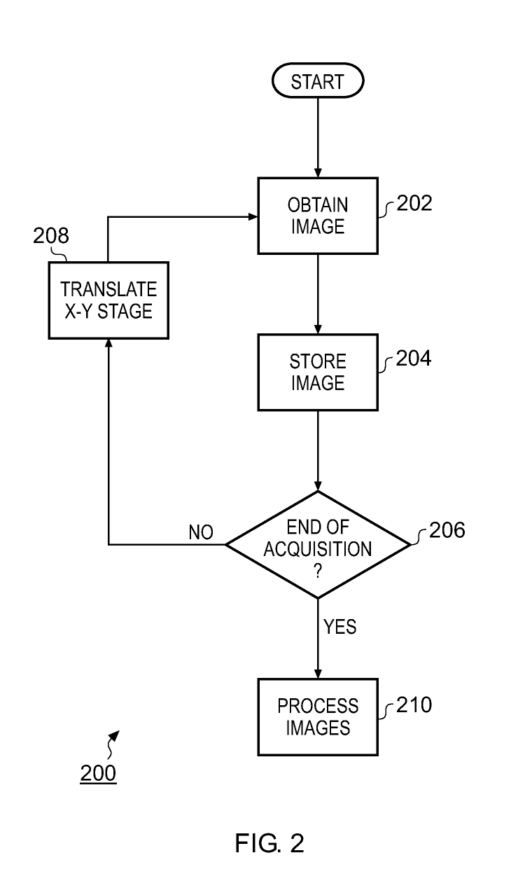

FIG. 2 shows a method 200 for acquiring and processing a plurality of original microscopy images in accordance with various aspects and embodiments of the present invention. The method 200 may, for example, be used to generate data for indicating the relative position of a test plate within an imaging system. Such data may in turn be used to provide improved accuracy spatial positional identification for individual of the original microscopy images.

At step 202 an image is obtained at a first x-y position at a fixed z-depth focal plane. For example, this image can be obtained using an imaging system of the type described in connection with FIG. 1, above. Optionally, a further step of setting an aperture stop prior to obtaining the image can be performed, for example, in order to enhance the contrast of the image.

Once obtained, the image is stored at step 204. At step 206 a decision is then made to determine whether or not any further images are to be acquired to complete an image of all the spots provided on the test plate being imaged.

If further images are to be obtained, a x-y stage translation is made to modify the position of the x-y position of the focal plane with respect to the test plate. The method 200 then moves back to step 202 and a further image is obtained. The further original image is then stored at step 204 and the decision step 206 repeats the x-y stage translation, image acquisition and storage steps until a set numbering k images is obtained (where k is an integer ≧2, for example, k may be a large number such as, for example, 22,528). Once the plurality of k images has been obtained, the method 200 moves on to processing step 210.

Processing step 210 involves generating data for indicating the relative position of the test plate within the imaging system. In one embodiment, described in greater detail below, the position indicating data is generated by processing each of the plurality of original images to reduce the information content therein, forming a composite image from the plurality of processed reduced information content images, identifying the spatial location of at least one fiducial marker in the composite image, and generating data indicating the relative position of the test plate within the imaging system from the spatial location of the at least one fiducial marker.

The original images may, for example, be generated following reverse transfection of siRNA material into cells provided at the spots provided on the test plate, as is known in the art. The step of processing each of a plurality of original images to reduce the information content therein may be implemented by reducing the bit depth of the images. For example, grey scale 12, 14 or 16-bit images obtained using a GE IN Cell Analyzer™ 1000 or equivalent imaging instruments can be compressed to 8-bit data using standard bit reduction methods. For example, reduction from 16 bit to 8 bit depth, wherein grey scale levels recorded separately at 16 bits are recorded as equivalent values at 8 bit depth, reduces the file size by approximately 50%. Additionally, significant further reduction in file size may be achieved by reducing the number of pixels in the image by downsizing the image, for example, to 10%, 5%, 1%, etc. of the original size.

In various embodiments, image downsizing is achieved using standard binning and interpolation techniques; e.g. 2×2 binning of pixels of a full resolution image of N pixels produces an image of N/4 pixels at 25% of the file size. The grey level of each resulting pixel is interpolated from the grey levels of the four parent pixels. All of the image manipulations may be carried out, for example, using non-compressed TIFF images where only the number of pixels representing a unit area is reduced.

The step of aiming a composite image from the plurality of reduced information content images, may, for example, be achieved by tiling the reduced size images together to form a montage. The montage thus formed may be of a significantly smaller data file size than would be an equivalent tiled montage of full resolution original images.

For example, using a GE IN Cell Analyzer™ 1000, the 16 bit grey scale images are each 2.8 MB; a stitched composite image covering a 22,528 feature array having one array spot per image would thus result in a composite image of 63 GB in size, making any image analysis using such a composite image highly impracticable using current computer systems. This can be compared to a montage provided in accordance with one embodiment of the present invention, in which a montage of images having a bit depth of 8 bits and a size reduced to 1% results in a composite image having a size of only 3.1 MB.

Having formed the composite image, the spatial location of at least one fiducial marker in the composite image is identified. The fiducial markers may be identified using standard image analysis techniques, e.g. thresholding and object identification, such as those used in IN Cell Investigator™ (available from GE Healthcare). The image may first be segmented according to a user-set threshold to identify pixels of intensity higher than the threshold, the resulting pixels then being subjected to object identification filters (size, shape etc.) to determine which groups of pixels belong to fiducial markers. Further analysis of identified objects may then be used to determine the centre of gravity of objects based on pixel intensity, yielding a spatial location for each marker object. The spatial location may be returned as an x,y coordinate for the centre of gravity of each spot.

Optionally, a spatial location or position marker is generated for each original image and each respective original image indexing with its respective spatial location marker identified from the composite image. For example, spatial position data can be appended to the original images as a small data file.

In various embodiments, spatial coordinates for each marker spot in the composite image are returned by the analysis of the composite image. Based on the known pixel dimensions of the composite image, the known pixel dimensions of the full resolution images used to form the montage and the downsizing ratio used, it is a straightforward operation to map the composite image into a grid map of locations corresponding to the full size images. Spot locations may then be assigned to full resolution images and the spot identity and centre of gravity recorded for each full size image within an XML metadata file associated with the stack of images acquired from the array. Such metadata may be recorded as a separate XML file or appended to an existing XML file containing image metadata, such as that generated during image acquisition using GE IN Cell Analyzer 1000™.

Application of the aforementioned technique provides many advantages. For example, processing is speeded up, and large high resolution arrays of detailed images can be processed/registered with improved accuracy. Additionally, various embodiments of the present invention can be provided as a software solution, instead of a hardware variant, and may thus be retrofitted to existing systems. For example, a software upgrade may be provided to a conventional GE IN Cell Analyzer™ 1000 to add enhanced functionality. The requirements to provide complex/expensive plate registration and/or alignment mechanisms (such as those often needed for plates having a large number (e.g. thousands) of array elements) is thus reduced. Additionally, such embodiments may also reduce mechanical tolerance requirements needed for various system components, such as, for example, the stepping stages used to move the plates within an imaging system.

Such embodiments are particularly useful when the original images are generated by imaging a plurality of spots provided on an siRNA test array, since many spots are used and high resolution images of such spots are also required.

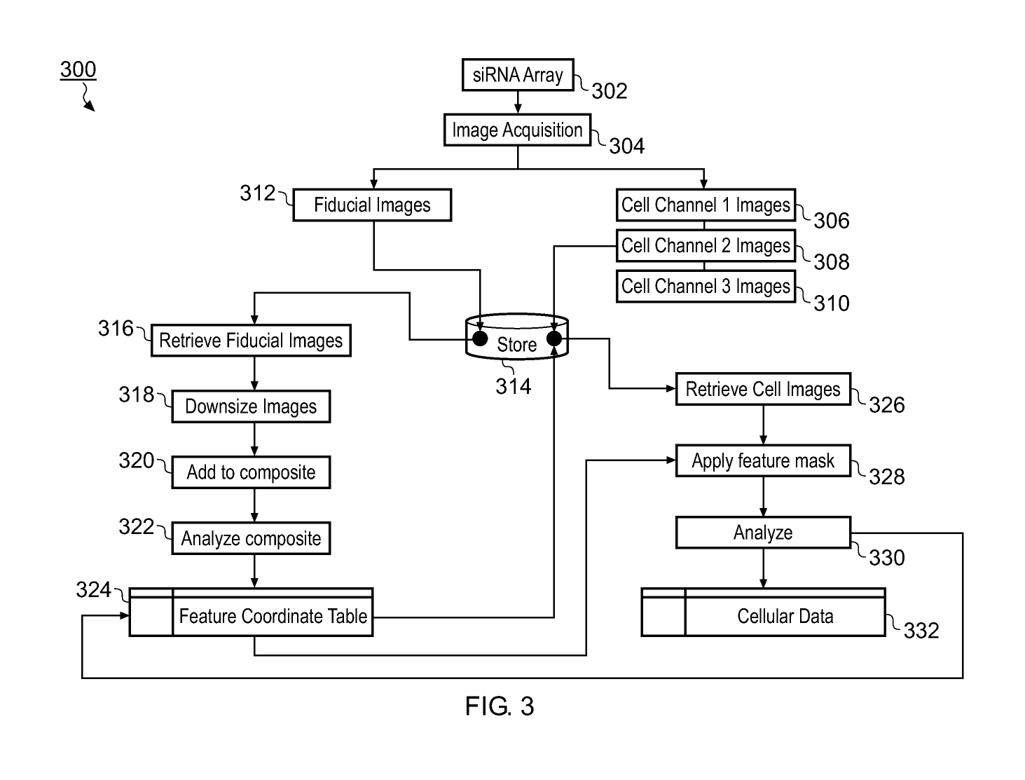

FIG. 3 shows a process workflow diagram 300 for use in a method according to various embodiments of the present invention. The method can be used to provide array feature identification and analysis using downsized image montaging. Additionally, the workflow described below may be used to address problems relating to feature-image registration by using whole array imaging, whilst also avoiding the need to generate impracticably large image files.

In the process workflow diagram 300 an siRNA array 302 is imaged 304 over an area with sufficient latitude relative to the array size and positioning of the array on the array plate to allow for variations in array or plate geometry; i.e. sufficient images are captured to ensure that all array features are captured. Images are captured for the channel used for fiducial markers 312 and for the number (e.g. 1-3) of cellular channels 306, 308, 310 as required by the user and stored 314.

Once all images are acquired, images in the fiducial marker channel 312 are recalled from storage 316, reduced in bit depth from 16 bit to 8 bit and downsized 318 to reduce the data file size. The resulting images are then composited 320 into an image montage containing the fiducial marker images for the entire array.

This composite image is then analysed 322 using, for example, GE IN Cell Investigator™ segmentation, to identify the fiducial markers and return the coordinates of each marker within the composite image. These coordinates are then used one-by-one to identify the locations of fiducial markers on the stored cellular channel images 306, 308, 310, recall 326 the appropriate image(s) from storage 314, and segment the full resolution 16 bit images to define regions of interest (i.e. the area of cells overlaying an array spot) for cellular analysis 332.

At step 328, segmentation is performed by application of the feature mask. For example, in the simplest implementation, the feature mask is a circle of diameter D centred on the full resolution image at coordinates x,y, where x,y is the centre of gravity of the spot determined by analysis of the composite image. Diameter D is a constant value representing the nominal diameter of array spots produced using a given spotting pin during array manufacture. Applying the feature mask to the full resolution images instructs the image analysis algorithm to analyse only those cells within the boundaries of the feature mask (cells within a distance of D/2 from x,y), i.e. those cells overlaying the array spot.

In a more complex embodiment, the feature mask may be derived from analysis of the composite image, i.e. the shape of the each spot object identified in the composite image is used as the basis of the feature mask. This embodiment allows for variations in spot size and/or shape arising during the array spotting process, however such an approach would require less downsizing of images for compositing in order to retain sufficient resolution in the composite image to generate an individual feature mask for each object.

This process of coordinate to image matching, image recall and image analysis is repeated for the entire array.

Advantageously, this process places no extra demands on processing power for image analysis. For example, using downsized images to create the composite feature results in an image file size not dissimilar to native GE IN Cell Analyzer™ images, and the process of analysing cellular images in a sequential fashion based on recall of images corresponding to feature positions is essentially the operation as would be carried out for conventionally acquired image stacks.

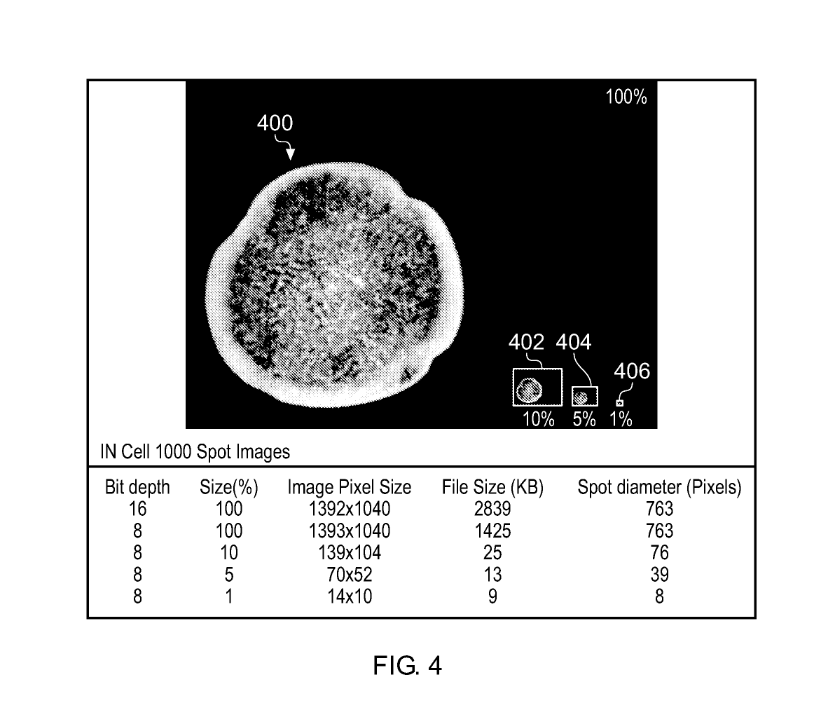

FIG. 4 shows a high resolution image of a single spot 400 obtained using a GE IN Cell 1000™ apparatus along with various reduced information content images 402, 404, 406 obtained therefrom. Such images may be obtained, for example, during application of a method in accordance with the process workflow shown in FIG. 3.

As may be seen from FIG. 4, down-sizing of fiducial images can be carried out to a high degree while still maintaining sufficient image information to segment and identify array features. For example, by reducing a native GE IN Cell Analyzer™ 16 bit image of array spot 400 to a 99% downsized 8 bit image 406, the file size is reduced from 2839 KB to 9 KB while retaining an array spot diameter of 8 pixels, which is sufficient for segmentation and feature identification in high contrast images of fiducial markers.

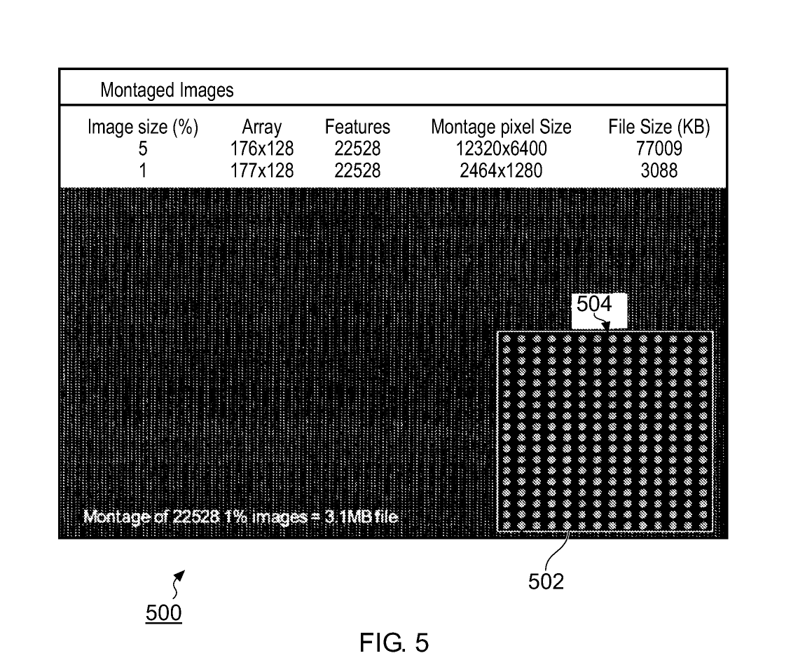

FIG. 5 illustrates a composite image 500 formed from a plurality of reduced information content images 502 in accordance with an embodiment of the present invention. A portion of the composite image 500 is shown magnified in the inset 504.

The composite image 500 is formed by combining multiple down-sized images 502 into an image montage covering the entire spot array. In this case, the composite image 500 is a montage of 22,528 1% images 502 which produces an image file which is only slightly larger than a native GE IN Cell Analyzer™ image. Combining the 22,528 fiducial images (i.e. 1 image/feature for a whole genome array) produces a montage file size of 3.1 MB, which is only approximately 10% larger than a single native GE IN Cell Analyzer™ image.

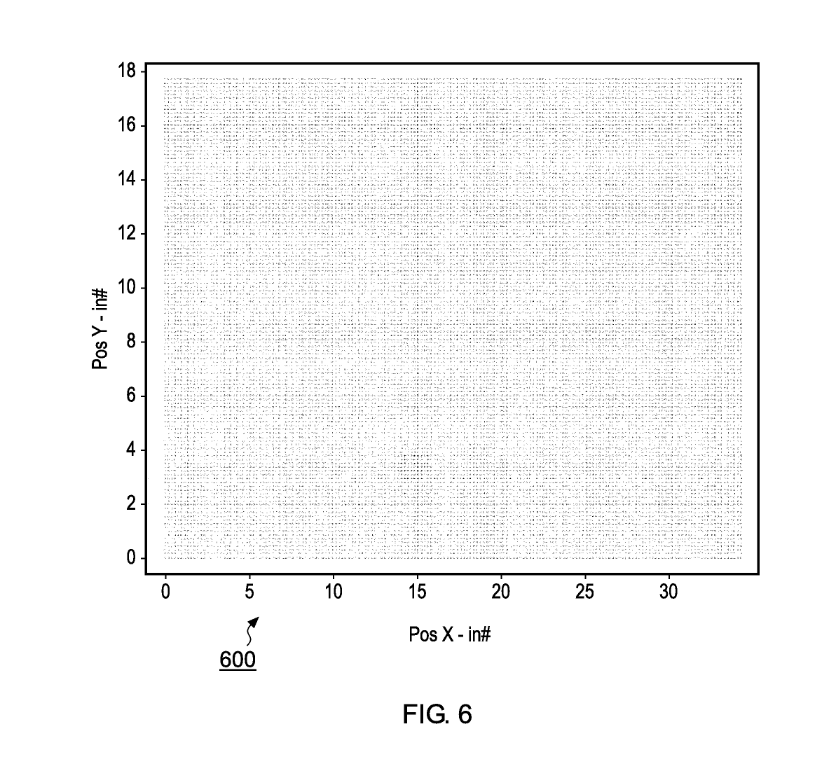

FIG. 6 shows a feature coordinates map 600 produced in accordance with an embodiment of the present invention.

A single GE IN Cell Analyzer 1000™ image of a fluorescent siRNA array spot was downsized in Photoshop™ from the native 16 bit 1392×1040 pixel image (2839 KB) to a 1% 8 bit 14×10 pixel image (9 KB). An empty 2462×1280 pixel image was then created in Photoshop™ and filled with a 176×128 array of the downsized 9 KB image yielding an 8 bit TIFF image montage comprising 22,528 features with a file size of 3088 KB.

The TIFF montage was then opened in Developer™ and segmented to identify features. Developer™ is an image analysis toolbox application incorporated within GE's IN Cell Investigator™ analysis software product. The feature coordinates were then exported to Microsoft Excel™ and then imported into Spotfire™. Spotfire™ being a commercially available data visualisation application available from TIBCO™ (http://spotfire.tibco.com/) that is provided under licence as part of the IN Cell Investigator™ analysis software.

Developer™ analysis correctly identified 22,528 array features from the composite image with a variance in feature to feature distance of 0.26%. Whilst results using a montage generated from multiple images of different array features are likely to be more variable due to inherent variations in spot morphology and positioning, nevertheless the model example described here serves to show that in principle a very large reduction in image size still retains enough information for accurate segmentation of array features by image analysis, and return of feature coordinates, to allow recall of full resolution images and masking of images for cellular analysis.

Various aspects of the present invention are thus able to acquire fiducial and cellular images covering an entire array without precise alignment of image and array area (i.e. imaging an area slightly larger than the array area sufficient to ensure that despite variance in array positioning the entire array is imaged), and then to use positions derived from fiducial imaging for analysis of cellular images. For such aspects, deriving feature positions from area imaging may use generation of an image montage covering the entire imaged area for segmentation and identification of markers. Since assembling a full resolution image montage would generate a file too large for image analysis using standard computer hardware, downsizing of fiducial images is used to generate a composite montage which can be analysed using, for example, standard GE IN Cell Investigator™ software. Marker positions derived from the composite image can then be used to sequentially retrieve high resolution cellular images for analysis.

Whilst various techniques have been discussed in connection with the present invention, those skilled in the art will realise that various functions can be implemented using computer program products. For example, a computer program product may be provided that is operable to configure an imaging system to implement one or more method steps of various algorithms according to embodiments of the present invention.

Certain embodiments may also include one or more of software, hardware and/or firmware components. For example, conventional imaging systems might be upgraded by using software components transmitted to various of those systems, for example, via the Internet, in order to enhance their functionality in accordance with the present invention.

For example, a software solution for imaging of siRNA arrays on a GE IN Cell Analyzer 1000™ or similar imaging instrument may be provided. This can be used to reduce the accuracy and precision requirements for stage alignment and movement. A software only approach may thus be provided in preference to a retro-fit hardware solution for installed base instruments where stage alignment and precision are known to vary between the instruments.

Various aspects and embodiments of the present invention may also be used as part of an automated microscope, e.g. in a GE IN Cell Analyzer 1000™ that is commercially available from GE Healthcare Life Sciences, Little Chalfont, Buckinghamshire, U. K. Such an automated microscope is easy to use and can be used by non-expert users, for example, to identify various bio-markers by analysing genetic switching in response to the siRNA in the presence of various drugs (e.g. breast cancer treatment resistance bio-markers may be identified by using cells in the presence of tamoxifen). Various other automated high-throughput genetic screening tests can also be undertaken. Additions of various aspects and embodiments of the present invention to such an automated microscope can thus not only make these even easier to use, but can also provide more rapid enhanced automated image registration with consequent analytical accuracy improvements.

Whilst the present invention has been described in accordance with various aspects and preferred embodiments, it is to be understood that the scope of the invention is not considered to be limited solely thereto and that it is the Applicant's intention that all variants and equivalents thereof also fall within the scope of the appended claims.

### REFERENCES

1. U.S. Pat. No. 6,990,221 (Biodiscovery)
2. U.S. Pat. No. 6,980,677 (Niles)
3. U.S. Pat. No. 6,826,313 (University of British Columbia)
4. U.S. Pat. No. 6,789,040 (Affymetrix)
WO 2008/065634 (Philips)
6. U.S. Pat. No. 7,359,537 (Hitachi)
7. U.S. Pat. No. 7,130,458 (Affymetrix)
8. U.S. Pat. No. 6,798,925 (Cognex)
9. U.S. Pat. No. 6,673,315 (Biomachines)
10. U.S. Pat. No. 6,362,004 (Packard)
11. U.S. Pat. No. 5,940,537 (Tamarack)
12. US 2004/208350 (Rea)
13. US 2002/150909 (Stuelpnagel)

Where permitted, the content of the above-mentioned references are hereby also incorporated into this application by reference in their entirety.

What is claimed is:

1. An imaging system (100) for providing improved spatial position identification of a plurality of microscopy images, the imaging system (100) comprising:
a light source (102) for producing light (120a);
a test plate (108) containing an array of spots (109) to be imaged;
a condenser (104) for focussing the light (120b) on the test plate (108);
a translation mechanism for moving the focal plane of the light (120b) relative to the test plate (108);
a detector system (112) configured to acquire a plurality of original images from respective spots (109); and
an image processing device (114) operable to process the plurality of images to generate data indicating the relative position of the test plate (108) within the imaging system (100);
wherein the image processing device (114) is further operable to:
process each of the plurality of original images to reduce information content therein resulting in a plurality of processed reduced information content images;
form a composite image from the plurality of processed reduced information content images;
identify the spatial location of at least one fiducial marker in the composite image; and
generate data indicating the relative position of the test plate (108) within the imaging system (100) from the spatial location of the at least one fiducial marker.

2. (canceled)

3. The imaging system (100) of claim 1, wherein the data indicating the relative position of the test plate (108) within the imaging system (100) includes respective position markers generated for each respective original image.

4. The test plate (108) for use in the imaging system (100) of claim 1, containing an array of spots (109).

5. The test plate (108) of claim 4, wherein the array of spots (109) is a large array.

6. The test plate (108) of claim 4, wherein the spots (109) contain siRNA material.

7. The test plate (108) of claim 4, further comprising at least one fiducial marker.

8. The test plate (108) of claim 7, comprising at least one coloured fiducial marker.

9. A method of spatially registering a plurality of microscopy images, the method comprising:
processing a plurality of original images of spots (109) to generate data indicating the relative position of a test plate (108) within an imaging system (100);
processing each of the plurality of original images to reduce information content therein resulting in a plurality of processed reduced information content images;
forming a composite image from the plurality of processed reduced information content images;
identifying the spatial location of at least one fiducial marker in the composite image; and
generating data indicating the relative position of the test plate (108) within the imaging system (100) from the spatial location of the at least one fiducial marker.

10. (canceled)

11. The method of claim 9, wherein the data indicating the relative position of the test plate (108) within the imaging system (100) includes respective position markers generated for each respective original image.

12. The method of claim 9, wherein the original images are generated following reverse transfection of siRNA material into cells provided at the spots (109).

13. A computer program product comprising machine instructions operable to configure a data processing apparatus to implement the method of claim 9.
